(19) United States
(12) Patent Application Publication
(10) Pub. No.: US 2026/0253090 A1
(43) Pub. Date: Aug. 27, 2026

(54) METHOD AND SYSTEM FOR AUTHENTICATING AND MANAGING ASSETS

(71) Applicant: RWA Chips & Cattle LLC, New York, NY (US)

(72) Inventors: Gareb Shamus, New York, NY (US); Stephen Shamus, New York, NY (US)

(21) Appl. No.: 19/465,082

(22) Filed: Jan. 30, 2026

Related U.S. Application Data
(60) Provisional application No. 63/826,008, filed on Jun. 18, 2025.
(60) Provisional application No. 63/753,616, filed on Feb. 4, 2025.

(51) Int. Cl. G06Q 30/018; G06Q 40/04

(52) U.S. Cl. CPC G06Q 30/0185; G06Q 40/055

(57) ABSTRACT

A digitally secured collectible asset representing a primary asset can be created by encasing and tagging a representative tangible item to create a collectible asset and tethering it to a cryptographically secured digital representation of the primary asset, the value or rights associated therewith being recorded on a shared, immutable digital ledger such as a decentralized blockchain-based network or platform. The encased tangible item can be a traditional trading card, miniature artwork, stock certificate, diploma, membership card, or larger pieces or other documents similarly encapsulated and tagged. Large or bulky physical items not suitable for encasement can be tagged with a primary security tag and further connected to the collectible asset and its tethered digital asset. For primary assets including intangible assets, memberships, or fractional ownership of assets, the primary asset can be connected to a tangible representation and further connected to the collectible asset and its tethered digital asset.

### CROSS-REFERENCE TO RELATED APPLICATIONS

This application claims the benefit of provisional U.S. Application No. 63/753,616, filed February 4, 2025, and provisional U.S. Application No. 63/826,008, filed June 18, 2025.

### FIELD OF THE INVENTION

This invention relates to systems and methods for authenticating and managing collectibles and other assets. More particularly, this invention relates to a system and method of authenticating and managing primary assets and collectible assets using physical encapsulation, tracking, and cryptographically secured digital assets representative of the primary or collectible asset.

### BACKGROUND OF THE INVENTION

Trading cards are among the most popular collectibles to sell. For sports cards alone, the market is valued at over $12 billion in 2025 and expected to grow almost three-fold over the next six years. Sports cards, however, only make up a portion of the trading card market. Cards with a massive demand include gaming cards, entertainment cards, comic cards, and artist cards. Entire marketplaces have grown around selling trading cards, and companies have grown around grading, certifying, authenticating, categorizing, and protecting individual cards. Despite their popularity and value, however, trading cards have yet to be adequately secured or adapted for trade using a decentralized computing system and digital database such as a blockchain-based marketplace.

Like trading cards, other items and assets have yet to be adequately secured or adapted for trade in management using a decentralized computing systems and digital databases or a blockchain-based marketplaces. Yet, almost any asset can be memorialized via collectibles and likewise be managed, traded, and authenticated using a blockchain network and marketplace, including real property, intellectual property, affiliations, diplomas, stock certificates, shared assets, memberships, comic books, stamps, coins, trading card games, DVDs, VHS tapes, and other video files and recordings, music albums, CDs, and other audio files and recordings, video games, action figures, currency, coins, medallions, chips, challenge tokens, special edition or rare books and journals, all types of printed works, architectural works, and all art, including fine art, originals, prints, photographs, sculptures, digital art, and remarques (remarks). Accordingly, there is a need for creating blockchain-secured collectibles for trading cards and other primary assets and methods of securing, managing, and monetizing existing collectibles and primary assets using blockchain technology.

### SUMMARY OF THE INVENTION

A digitally secured collectible asset that includes or represents a primary asset can be created by encasing or encapsulating in a tamper-proof or tamper-resistant case a tangible or physical item such as a trading card with a collectible item security tag such as an authentication-type NFC chip. The collectible item security tag and thereby collectible item can be linked to a digital asset such as a non-fungible token that is a cryptographically secured digital representation of value or rights that is recorded on a shared, immutable digital ledger such as a decentralized blockchain-based network or platform. The collectible item security tag preferably adheres to, or is embedded in, the tangible item, and additional features can be applied to the tangible item or included as part of the collectible asset including autographs, codes, dates, edition and/or series information, and quality grading. Alternatively, the collectible item security tag may be affixed to the interior surface of the encapsulation, positioned between layers of the encapsulation, affixed to, or integrated with, the label used with the encapsulation, or affixed to the exterior of the encapsulation. The encapsulated tangible item can be a traditional trading card, miniature artwork, stock certificate, diploma, membership card, coin, or larger pieces or other documents similarly encapsulated and tagged. Where a physical item is too large or bulky for encasement or encapsulation, such as a sculpture, the large physical item can be tagged with a primary security tag and further connected to a replica, representation, or image of the item that is tagged with the collectible item security tag and encased or encapsulated. For some primary assets including intangible assets, memberships to an exclusive club, or fractional ownership of real property, the primary asset can be connected to a tangible representation such as a club logo or a picture of real property or a deed that is likewise tagged with the collectible item security tag and encased or encapsulated.

To transfer ownership or otherwise control aspects of a primary asset or collectible asset, a seller must transfer or control the tethered group that includes the primary and collectible assets along with the cryptographic digital asset according to established asset control protocols, which creates a digital record of the transaction and provides enhanced security and authentication. Preferably, the owner of a primary asset can also sell the primary, collectible, and digital assets according to blockchain protocols on a marketplace accessed preferably through an online network. Additionally, owners can register their collectible assets and primary assets, set up smart contracts (such as to facilitate royalty payments to a copyright owners) if desired, or alert others if a collectible or primary asset has been lost or stolen. Primary asset owners can further establish ownership groups with collectible assets and associated digital assets representing fractional ownership of shared assets, and organizations issuing memberships can control membership privileges and access for individual members or membership groups. As primary, collectible, and digital assets change hands, a historical record of ownership is created, and valuable information can be easily transmitted. Connecting collectible and primary assets to a digital asset provides an especially secure transaction that is serially identifiable, highly individualized, traceable, and resistant to counterfeiting.

The above summary is not intended to represent every embodiment or every aspect of the present disclosure. Rather, the foregoing summary merely provides an exemplification of some of the concepts and features set forth herein. The above features and advantages, and other features and advantages of this disclosure, will be readily apparent from the following detailed description of the illustrated examples and representative modes for carrying out the present

disclosure when taken in connection with the accompanying drawings and the appended claim. Moreover, this disclosure expressly includes any and all combinations and subcombinations of the elements and features presented above and below.

### BRIEF DESCRIPTION OF DRAWINGS

FIG. 1A is a front view of a secured collectible asset according to the preferred embodiment of the present invention.

FIG. 1B is a back view of a secured collectible asset according to the preferred embodiment of the present invention.

FIG. 1C is a perspective exploded view of a secured collectible asset according to the preferred embodiment of the present invention.

FIG. 1D is a front view of a secured collectible asset according to an alternate embodiment of the present invention.

FIG. 1E is a front view of a secured collectible asset according to an additional alternate embodiment of the present invention.

FIG. 2 is an illustration of a secured collectible asset and associated items according to the preferred embodiment of the present invention.

FIG. 3 is an illustration of a secured collectible and associated items according to an alternative embodiment of the present invention.

FIG. 4 illustrates a method of securing and monetizing assets according to a first embodiment of the present invention.

FIG. 5 illustrates a method of securing and monetizing assets according to a second embodiment of the present invention.

FIG. 6 illustrates a method of securing and monetizing assets according to a third embodiment of the present invention.

FIG. 7 illustrates a method of enrolling a collectible asset and digital assets on a marketplace according to the preferred embodiment of the present invention.

FIG. 8 illustrates a method of buying a collectible asset or digital assets on a marketplace according to the preferred embodiment of the present invention.

FIG. 9 illustrates how an asset owner can sell collectible assets and digital assets to multiple buyers on a marketplace according to the preferred embodiment of the present invention.

FIG. 10 is an illustration of a primary asset having fractional owners and associated collectible assets according to an alternative embodiment of the present invention.

FIG. 11 illustrates how a group of asset owners can represent their ownership using collectible assets and digital assets that can be stored and monetized on a marketplace according to an embodiment of the present invention.

FIG. 12 is an illustration of an asset such as a club membership that can be represented with collectible and digital assets according to an alternative embodiment of the present invention.

FIG. 13 illustrates how a membership can be represented with collectible and digital assets for membership access and privileges and for monetization according to an embodiment of the present invention.

FIG. 14 is a front view of a secured diploma according to an embodiment of the present invention.

FIG. 15 is a front view of a first embodiment of a secured stock certificate according to an embodiment of the present invention.

FIG. 16A is a front view of a second and preferred embodiment of a secured stock certificate according to an embodiment of the present invention.

FIG. 16B is a back view of the second and preferred embodiment of a secured stock certificate according to an embodiment of the present invention.

FIG. 16C is a front view of the digital asset associated with the second and preferred embodiment of a secured stock certificate according to an embodiment of the present invention.

For a better understanding of the invention, reference is made to the following detailed description of the preferred embodiments of the invention which should be taken in conjunction with the above-described drawings. Corresponding reference characters indicate corresponding elements among the view of the drawings. The headings used in the figures should not be interpreted to limit the scope of the claims.

### DETAILED DESCRIPTION OF THE INVENTION

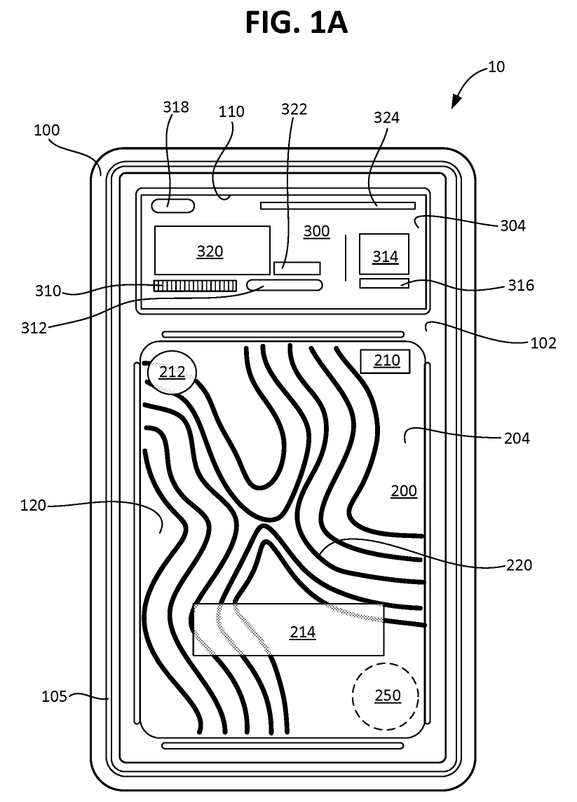

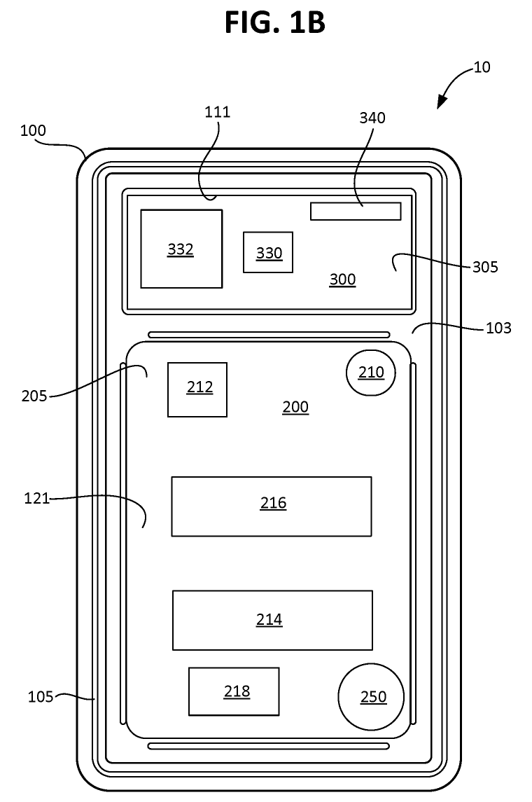

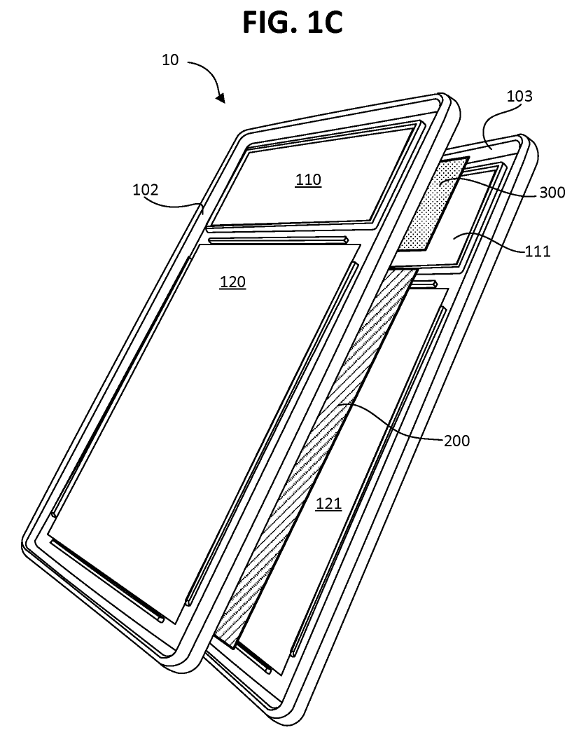

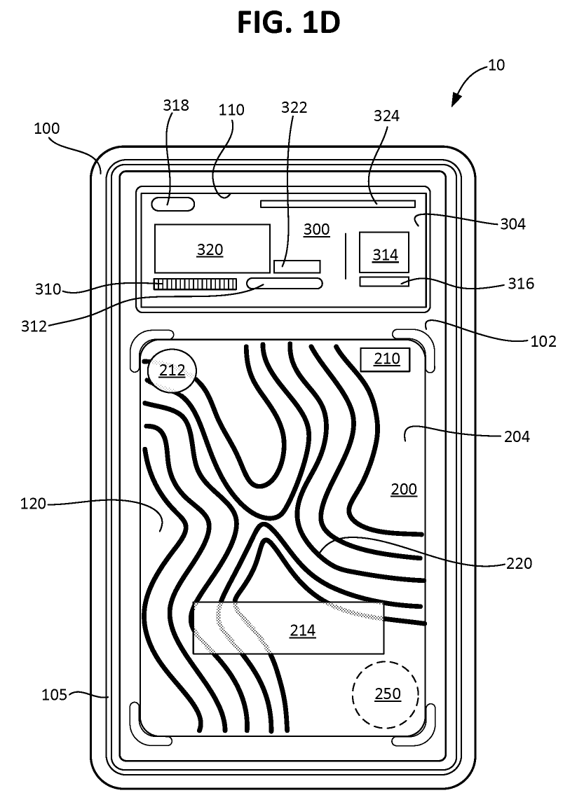

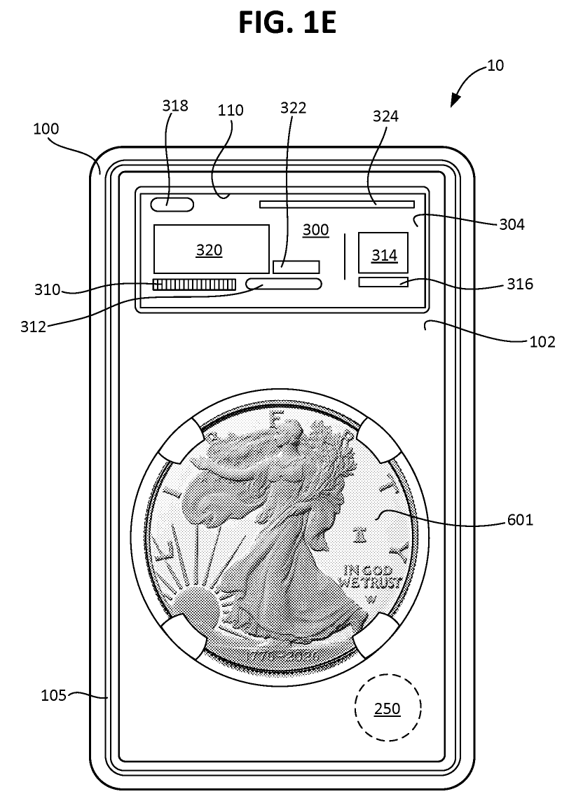

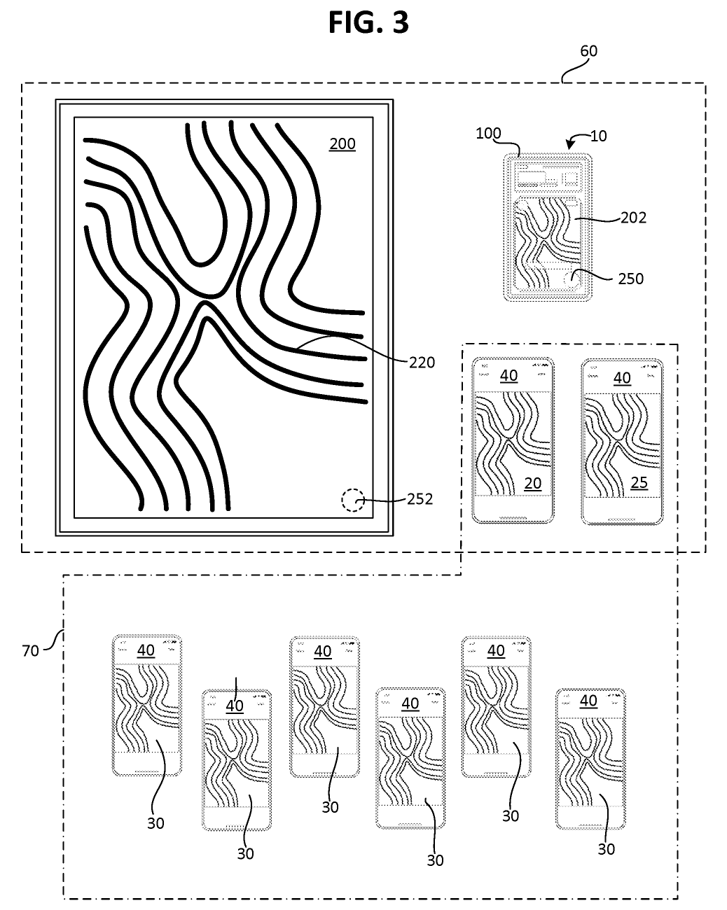

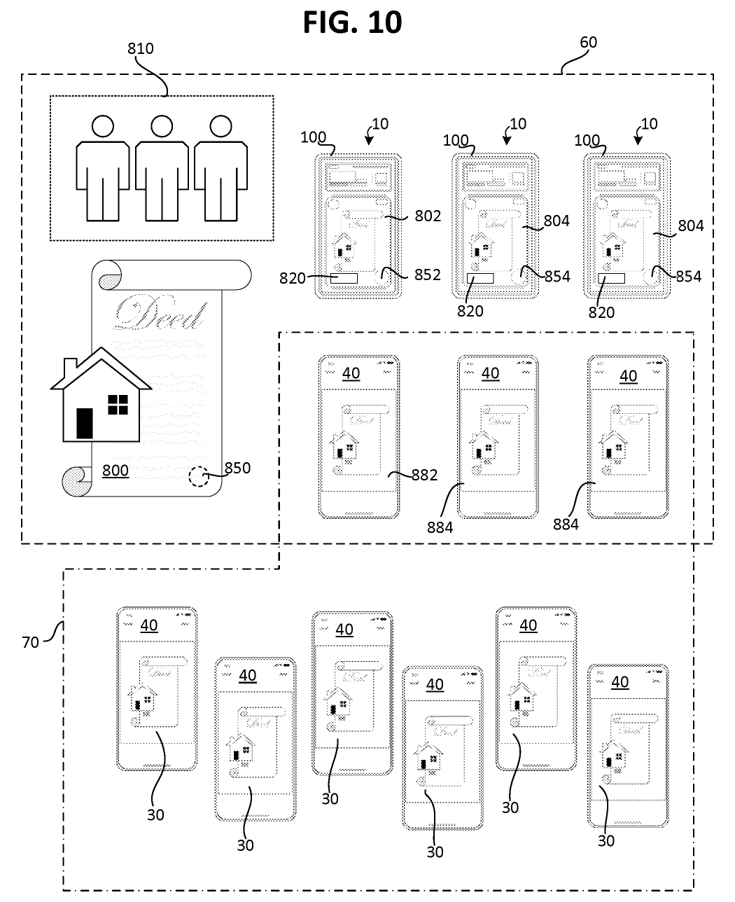

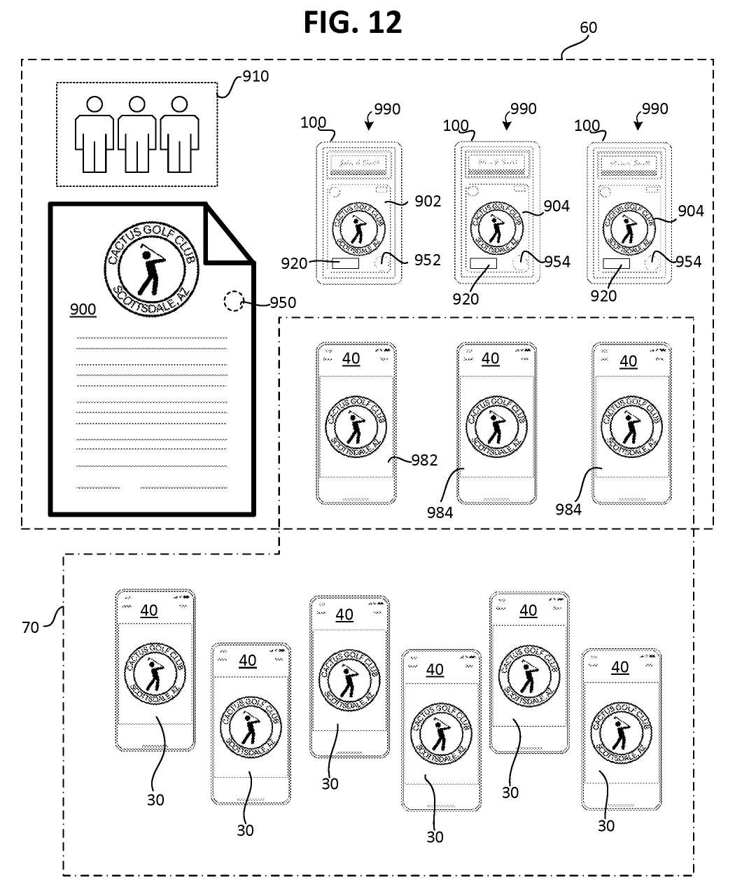

A secured collectible asset 10 suitable for trade using decentralized computing system and digital database such as a blockchain-based marketplace includes a tangible item 200 such as a trading card, which is optionally enhanced with features and identifiers, a protective case 100, and a collectible item security tag 250 as shown in FIGS. 1A-1E. The secured collectible asset 10 can alternatively be a representation or replica 202 of a primary asset 12 enhanced with features and identifiers, a protective case 100, and a collectible item security tag 250 that is further associated with a separate tangible or intangible primary asset 12 associated with an optional second, primary security tag 252 as shown in FIG. 3. Similarly, the secured collectible asset 10 can be a physical representation of an intangible primary asset 12 or other primary asset 800, 900 (e.g., card with logo to represent club membership, printed image of home or building to represent real property ownership interest) enhanced with features and identifiers, a protective case 100, and a collectible item security tag as shown in FIGS. 10 and 12. Examples of primary assets 12 suitable for the present invention include but are not limited to real property, intellectual property, affiliations, diplomas, stock certificates, shared assets, membership agreements, comic books, stamps, coins, trading card games, DVDs, VHS tapes, and other video files and recordings, music albums, CDs, and other audio files and recordings, video games, action figures, currency, coins, medallions, chips, challenge tokens, special edition or rare books and journals, all types of printed works, architectural works, and all art, including fine art, originals, prints, photographs, sculptures, digital art, and remarques (remarks).

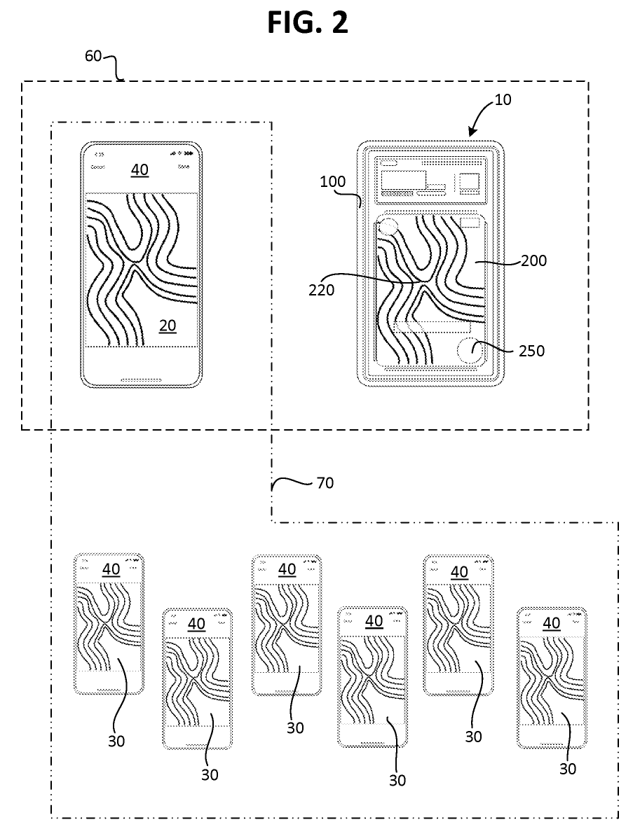

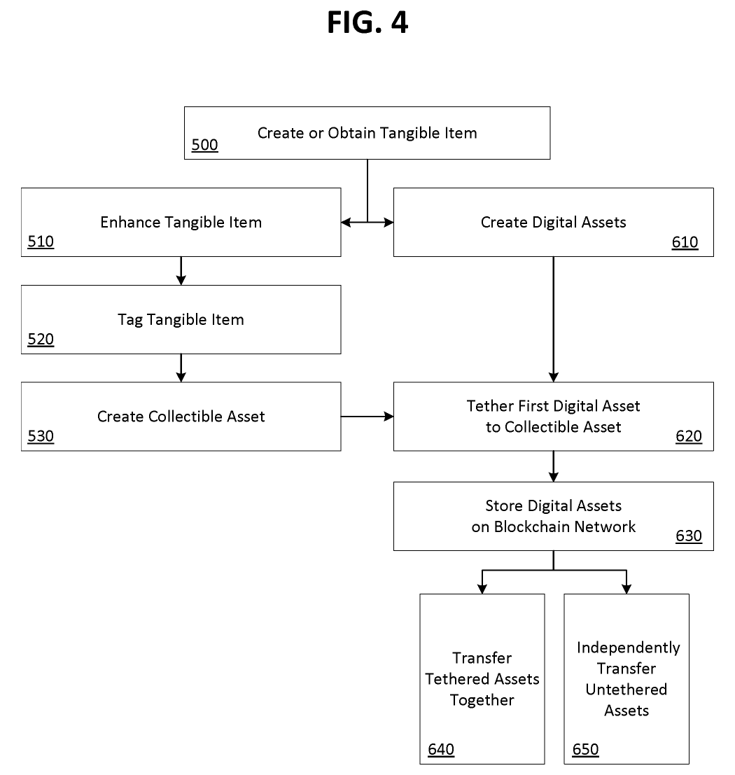

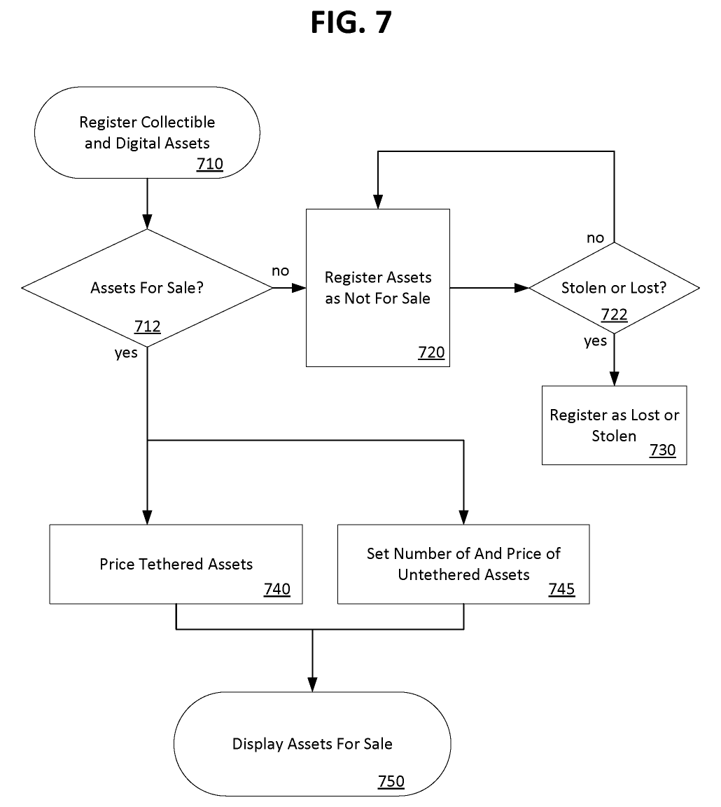

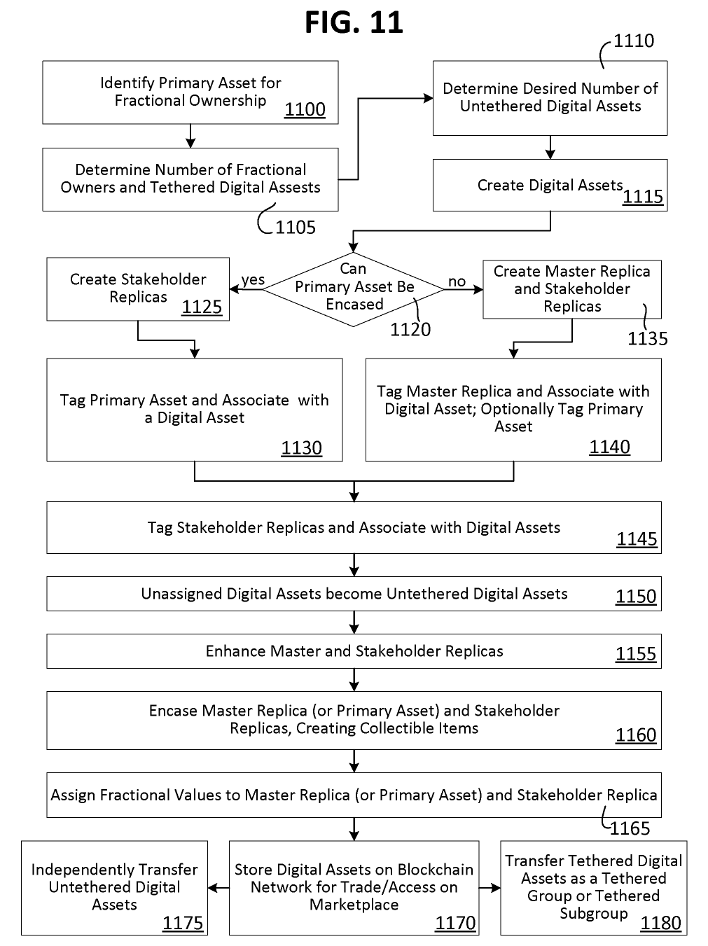

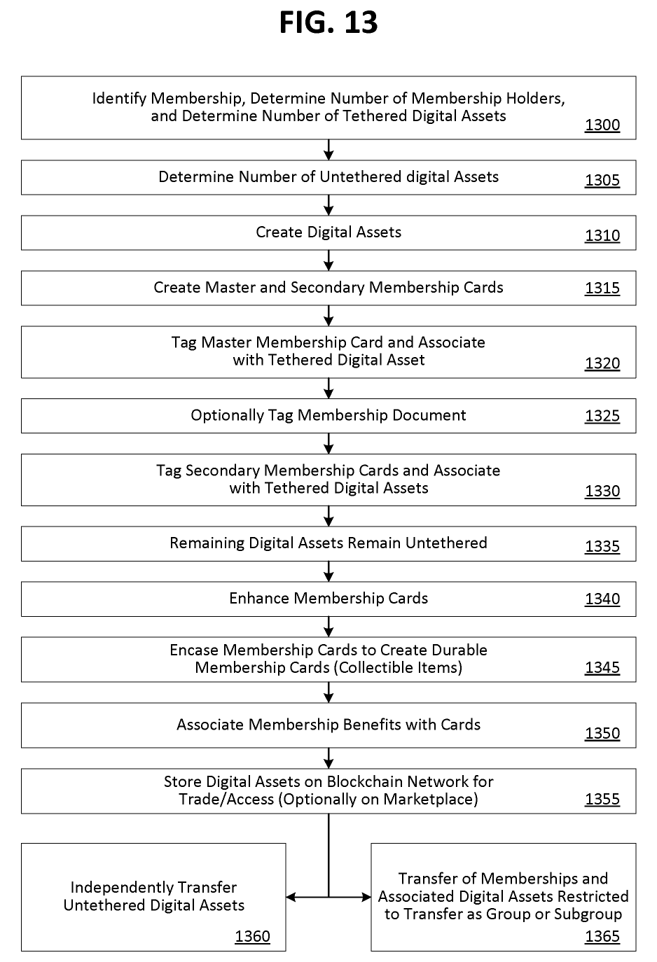

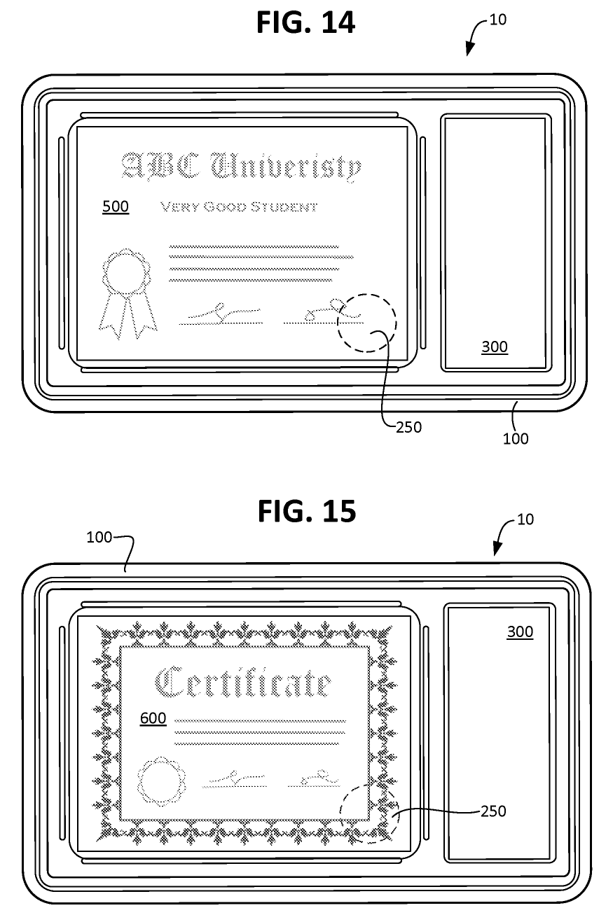

FIGS. 2-3 illustrate how each collectible asset 10 is preferably associated with one or more non-fungible tokens (NFT), which are cryptographic digital assets 70 like a piece of digital art, digital content, or video that represent value or rights and are recorded on decentralized computing systems via a shared, immutable digital ledger such as a decentralized blockchain-based network. FIGS. 4-6 illustrate how tangible items 200 and optionally replicas 202 or primary assets 12 can be physically secured with security tags 250, 252 and associated with tethered NFTs 20, 25 for enhanced blockchain authentication and security. Additionally, FIGS. 4-6 illustrate how physical assets 200 can be further controlled or monetized by associating them with a predetermined number of untethered NFTs 30. FIGS. 7-9 illustrate how a collectible owner 5 can sell collectible assets 10 and untethered NFTs 30 on a marketplace 50 over a network 90 according to asset control protocols and with the blockchain security of a distributed network ledger 80. Finally, FIGS. 10-11 illustrate examples of how the materials and methods described herein can be applied to and used for fractional ownership of assets, and FIGS. 12-13 illustrate how the materials and methods described herein can also be applied to and used for assets such as memberships to clubs or organizations, and FIGS. 14-16C illustrate how the materials and methods described herein can be applied to and used for assets such as diplomas and stock certificates.

As shown in FIGS. 1A-1E, a collectible asset 10 is preferably of archival quality and encapsulated or stored in a protective case 100 that preferably prevents against or minimizes access to the contents of case 100 making it tamper-resistant or tamper-proof. Case 100 preferably is made of plastic and has a front panel or section 102 and a back panel or section 103 that are bonded or welded together such as with laser welding or ultrasonic welding at ridge 105, which encapsulates the contents of case 100 and creates a slab. Front and back sections 102, 103 are preferably at least partly transparent and optionally include colorful solid, patterned, or somewhat transparent aspects such as along its edges (not labelled). Overall, case 100 is preferably about 3-3.5 inches by 5-6 inches in size, but case 100 can be made larger, smaller, thicker, or with a different aspect ratio depending on its contents. For example, case 100 can be large enough to hold a comic book or artwork or small enough to hold a collectible stamp or coin. Preferably, case 100 includes tabs, corners, or edges (not labeled) that hold the tangible item in a fixed position. For example, FIGS. 1A-1C illustrate side edges holding a rectangular card in place, FIG. 1D illustrates corners holding a rectangular card in place , and FIG. 1E illustrates tabs holding a coin in place.

Front section 102 of case 100 further preferably defines a first front window 110 and a second front window 120, both of which are transparent, preferably providing crystal clear optics and UV protection. Preferably, first front window 110 is sized to display an information card, and the second front window 120 is sized to display contents the size of a trading card, about 2.5 inches by 3.5 inches. Likewise, back section 103 further defines a first back window 111 and a second back window 121, both of which are transparent, preferably providing crystal clear optics and UV protection. Preferably, first back window 111 is sized to display an information card, and the second back window 121 is sized to display contents the size of a trading card, about 2.5 inches by 3.5 inches. Optionally, front and back windows 110, 111, 120, 121 can be larger or smaller depending on the contents encased by case 100.

Preferably, case 100 is sized and configured to display a trading card sized tangible item 200 or a trading card sized representation or replica 202 of a larger tangible or intangible primary asset 12. The trading card sized tangible item 200 or replica 202, is generally a flat item having the thickness of paper or cardboard and more preferably having a thickness of about or less than 7.5 mm. The tangible item 200 or replica 202 has a front side 204 and back side 205, where the front side 204 can be viewed through the second front window 120 and the back side 205 can be viewed through the second back window 121 when encapsulated in case 100. Preferably, item 200 or replica 202 displays art, a character, a famous person or athlete, a photograph, or any other unique or valuable content 220. Also preferably, item 200 or replica 202 is enhanced with features designed to increase its value and indicate authenticity. For example, item 200 or replica 202 may be enhanced with some or all of the following: information about its edition or with a foil 212, information about its series and edition number 210, a validity stamp or autograph 214, a title 216, and/or an autograph date 218. FIGS. 1 and 2 illustrate how such enhancements can be positioned on item 200 or replica 202 but such enhancements can be placed anywhere on item 200 or replica 202.

Preferably, case 100 also encases a panel or information card 300 with a front side 304 and back side 305. Information card 300 can provide additional information and enhancements that compliment or are coupled to tangible item 200 or replica 202. For example, information card 300 may include some or all of the following information: a barcode 310, a unique code 312, the grade 314 of the tangible item 200, the autograph grade 316, series information 318, additional context 320, a date stamp 322, notarization 324, a QR code 330, a sticker 332, and branding 340. FIGS. 1A-1E illustrate how such enhancements can be positioned on information card 300 but such enhancements can be placed anywhere on information card 300.

Attached to or embedded in tangible item 200 or replica 202 is a collectible item security tag 250 for providing digital authentication and optionally for displaying information about tangible item 200 and/or replica 202. Likewise, a primary security tag 252 can be attached to or embedded in the primary asset 12 where possible. Collectible item and primary security tags 250, 252 are preferably near field communication (NFC) chips but can also include or be chips employing radio frequency identification (RFID) with a longer read range, Bluetooth Low Energy (BLE), ultrasonic technology, and Wi-Fi. In the preferred embodiment, security tags 250, 252 are authentication-type NFC chips that can be applied to tangible item 200, replica 202, and/or primary asset 12 as a sticker. More preferably, security tags 250, 252 are a sticker-type NFC chip that are applied to the back side 205 of tangible item 200 or replica 202 and to an inconspicuous location of primary asset 12. While security tag 250 can be affixed to the tangible item 200 or replica 202, security tags 250 also can be affixed to the interior surface of case 100, positioned between layers of case 100, affixed to or integrated with the label used with case 100, item 200, or replica 202, or affixed to the exterior of the case 100. Security tag 250 can be encapsulated with item 200 or replica 202 during the sealing or ultrasonic welding process, can be embedded into a label so that it is both a readable label and contactless digital tag, adhered to or thermally bonded to other surfaces (such as the surface of case 100), or applied to item 200, replica 202, or case 100 in any manner that is secure, durable, and tamper-resistant. Authentication NFC chips generate a unique code with each scan making them more secure. This unique code can be verified on the server to provide a very high level of confidence that the NFC tag is what it claims to be and therefore the object that it is attached to is genuine.

Collectible item security tag 250 and primary security tag 252 are preferably able to be read by a dedicated tag reader or mobile application, which interact wirelessly or through a wired connection to a decentralized computing system for identification and authentication. For example, security tags 250, 252 preferably cooperates with an NFC chip reader mobile application (chip reader app). When the chip reader app senses one of security tags 250, 252, it accesses a unique URL or asset contract and creates a secure, unique dynamic digital link for identification and authentication purposes. Using an authentication-type NFC chip, tangible item 200, replica 202, or primary asset 12 can be authenticated only when accessed on item 200, replica 202, and primary asset 12 (as opposed to through messages, email, or an online link), allowing for a verifiable and unclonable link to a digital asset 70, which is discussed further before and preferably according to asset control protocols established by the initial owner or creator of the primary or collectible asset.

According to the preferred embodiment, each collectible asset 10 is paired with one or more digital assets 70 which are stored on one or more free or subscription-based databases 94 and for which non-fungible tokens (NFTs) are the certificate of ownership. Preferably, each collectible asset 10 is paired with one tethered digital asset and non-fungible token (NFT) 20, preferably forming a group of tethered assets 60, and optionally with an additional predetermined number of untethered digital assets 70 and NFTs 30. NFTs are unique digital certificates that are preferably stored on a network or platform using blockchain 80 or other form of a decentralized digital ledger or a distributed ledger network. This makes it almost impossible to alter the information because each change in information is linked to the previous state and all information is stored on any number of computers or servers. No single server controls or manages the data, and anyone trying to alter information on one server will be overruled by the rest of the network. Decentralized digital ledgers or distributed ledger networks such as blockchain 80 are therefore useful to record an asset’s ownership and history as an NFT or digital certificate, creating what is known as provenance by those in the art market. By connecting a tethered NFT 20 with collectible asset 10 and where applicable a primary asset 12, NFT 20 serves both as a certificate for the current owner and as an immutable chain containing the history of the digital asset. Collectible item security chip 250 confirms the authentication of collectible asset 10, primary item security chip 252 confirms the authentication of primary asset 12, and tethered NFT 20 confirms the ownership/authentication of the digital asset 70.

Digital assets 70 are generally accessed using a program 90 executed by decentralized computing systems that include computing components housed on one or more computing devices such as mobile devices, servers, and personal computers. Program 90 can be a stand-alone, self-contained executable or a browser-based application that runs on a browser on a computer device, and computing devices include any necessary control and processing components such as a processor, memory, input and output components, wireless or wired communication components, or any other feature of a computer, computing system, or computer network as is well known in the art. Preferably, program 90 runs on a computing device having a wired or wireless connection to a network 92 such as the Internet, which also connects to database 94. Database 94 may be hosted on websites or made available as software as a service product accessible via a web browser and preferably includes multiple functions such as providing authentication data for collectible asset 10 and any digital assets 70. Digital assets 70 can further be linked with a cryptocurrency wallet accessible through program 90 and registered with the platform hosting or using the blockchain 80 ledger.

Program 90 preferably executes an asset control protocol or protocols specific to a collection of assets (e.g. a primary asset and any associated physical and digital assets including any groups of tethered assets – a collection of assets is shown, for example, in FIGS. 2, 3, 10, and 12 as the combination of tethered assets 60 and any additional digital assets 70). The asset control protocol dictates how a collection of assets can be managed, transferred, distributed, divided, shared, and otherwise controlled. For example, the asset control protocol can dictate that ownership of the primary asset can only be transferred along with any associated collectible assets and first digital assets while allowing independent transfer for second digital assets associated with the asset collection. Examples of asset control protocols are described herein for multiple different types of primary assets. Preferably, the creator or first owner of a collection of assets sets the asset control protocol.

An example of the relationship between, and framework for an asset control protocol for, a collectible asset 10 encapsulating a tangible item 200 and its tethered NFT 20 and untethered NFTs 30 is shown in FIG. 2, and an example of the relationship between, and framework for an asset control protocol for, a primary asset 12, a collectible asset 10 encapsulating a replica 202 of the primary asset 12, and its tethered NFTs 20, 25 and untethered NFTs 30 is shown in FIG. 3. In both FIGS. 2 and 3, NFTs 20, 25, and 30 are shown being digitally displayed on a mobile device 40, and all tethered NFTs 20, 25 are shown as part of a connected group with their tethered physical components, called herein a first group of tethered assets 60. In FIG. 2, first group of tethered assets 60 includes tethered NFT 20 and collectible asset 10, which encapsulates an original tangible item 200 (which can also be a primary asset 12) and a first security tag 250. In FIG. 3, first group of tethered assets 60 includes primary asset 12 with a primary security tag 252 that is tethered to NFT 25 and collectible asset 10, which encapsulates a replica 202 of primary asset 12 and a collectible item security tag 250, that is tethered to NFT 20. The tethered NFTs 20, 25 shown in FIGS. 2 and 3 can only be controlled or transferred along with transfer of ownership of the other items in first group of tethered assets 60. The second digital assets, which are the untethered NFTs 30 shown in FIGS. 2 and 3, can be transferred independently of the items in first group of tethered assets 60.

FIGS. 4-6 illustrate methods of connecting tangible items 200 to digital assets 70. FIG. 4 shows how a single tangible item 200 can be encapsulated and associated with a first digital asset (tethered NFT 20) and N untethered second digital assets (NFTs 30) and how the tethered and untethered NFTs 20, 30 are stored on a platform using blockchain 80 for trade and/or access on a marketplace 50 according to asset control protocols. In this example, tangible item 200 may be one and the same with primary asset 12. As shown, an owner 5 obtains or creates 500 a tangible item 200 for trade on marketplace 50 and then optionally enhances 510 the tangible item 200 with information, ratings, or other details as the user wishes. The owner 5 also attaches or causes to be attached 520 a collectible item security tag 250 to the tangible item 200 and encases or caused to be encased 530 both the tangible item 200, any enhancements, and the collectible item security tag 250 in a case 100, creating collectible asset 10. Collectible security tag 250 can be applied to or embedded in tangible item 200 or applied to or embedded in case 100 adjacent or near to tangible item 200. At the same time, owner 5 creates are causes to be created 610 N+1 digital assets 70 and links 620 them to collectible asset 10. Preferably, digital assets 70 include both a first digital asset 20 (or tethered NFT 20) and N second digital assets (or untethered NFTs 30). Digital assets 70 can be stored 630 on a network or platform using blockchain 80 for trade, access, and control on a marketplace 50. Preferably, collectible asset 10 and tethered NFT 20 form a first group of tethered assets 60 than can only be transferred 640 together according to established asset control protocols. Also preferably, untethered NFTs 30 can be transferred 650 independently of the first group of tethered assets 60.

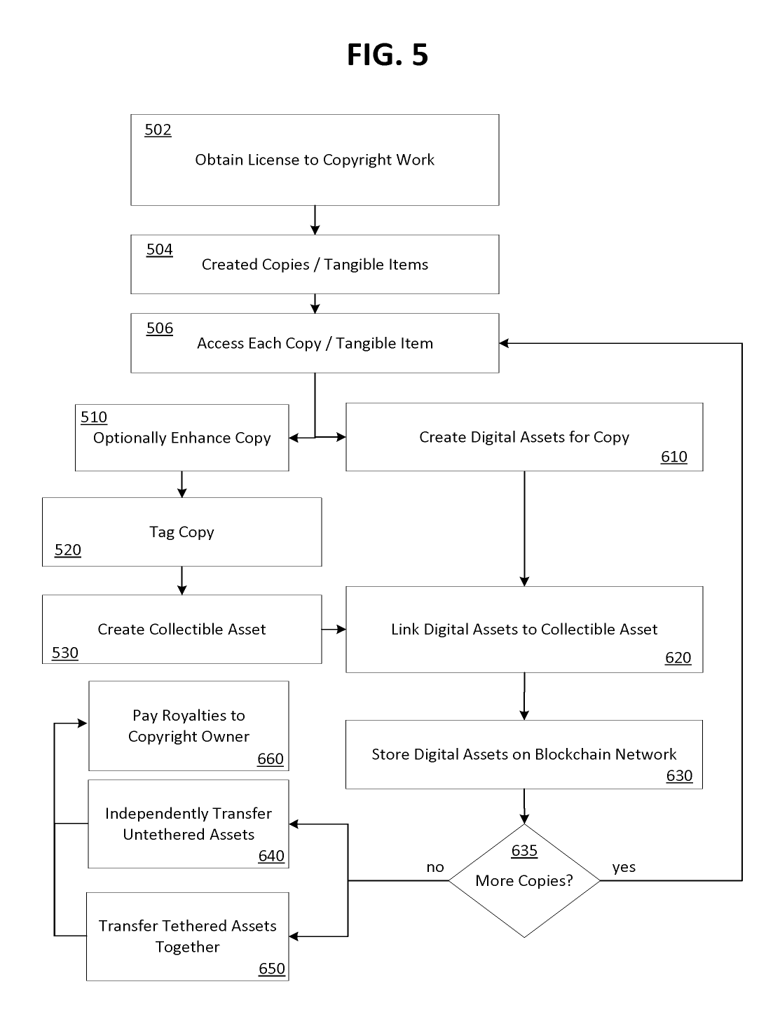

FIG. 5 expands on the method shown in FIG. 4 and illustrates how one might obtain the rights 502 to produce multiple copies of a copyrighted work along with digital assets 70 associated with each copy. Specifically, a copyright owner or licensee makes 504 N copies or tangible items 200. Then, accessing 506 each tangible item 200, enhances 510 it as described above, tags it 520 with a collectible item security tag 250 as described above, and then creates 530 a collectible asset 10 by encasing the tangible asset 100 and security tag 250 as described above. At the same time, the owner or licensee creates 610 X+1 digital assets 70 for each collectible asset 10. Preferably, digital assets 70 include both a first digital asset 20 (or tethered NFT 20) and X second digital assets (or untethered NFTs 30). Digital assets 70 can be stored 630 on a network or platform using blockchain 80 for trade, access, and control on a marketplace 50 according to the set asset control protocols. The owner or licensee continues to create the collectible assets 200 for the copies as needed, repeating the above steps. Preferably, each collectible asset 10 and tethered NFT 20 form a first group of tethered assets 60 than can only be transferred 640 together. Also preferably, untethered NFTs 30 can be transferred 650 independently of the first group of tethered assets 60 and optionally using smart contracts to pay royalties 660 to the copyright owner as groups of tethered assets 60 and untethered NFTs 30 are transferred. Because multiple collectible assets 200 are formed, there can be multiple first groups of tethered assets 60.

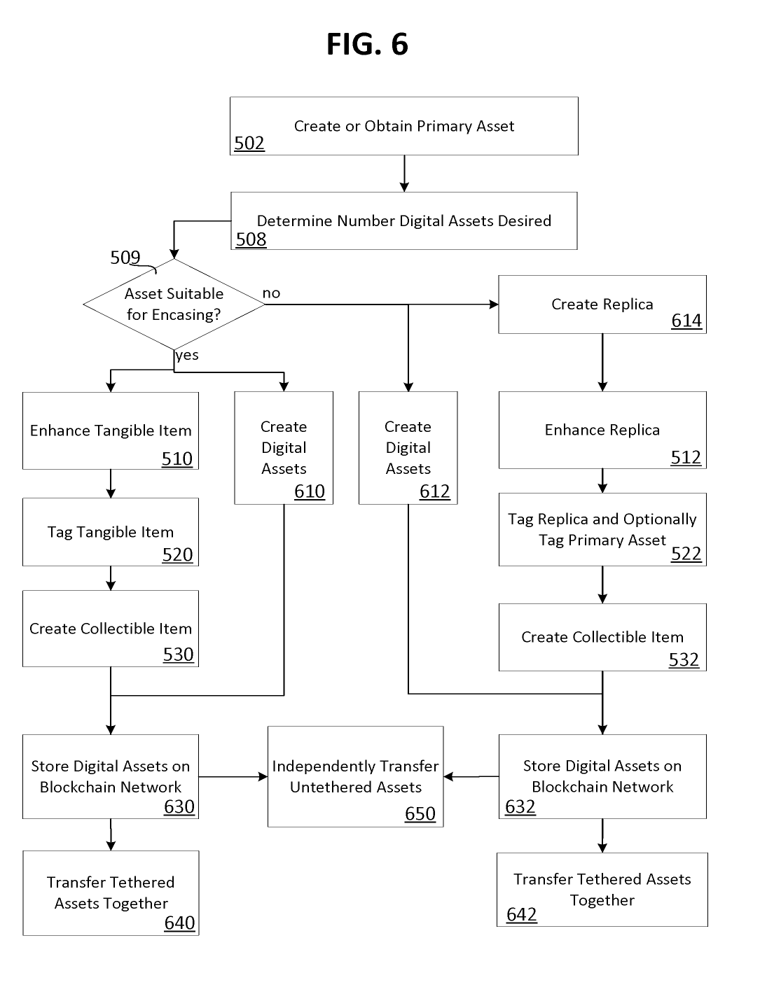

FIG. 6 expands on the method shown in FIG. 4, illustrating how one might combine a large or bulky primary asset 12 with a replica 202 for authentication and trade using blockchain 80 and a marketplace 50 with two first digital assets or tethered NFTs 20, 25 and N second digital assets or untethered NFTs 30. As shown, an owner creates or obtains 502 access to a primary asset 12 for trade on marketplace 50 and determines 508 the total number N of digital assets 70 to associate with the primary asset 12 depending in part on whether the primary asset 12 is suitable for encasing 509. If the primary asset 12 is suitable for encasing, then N+1 digital assets are created 610 and the primary asset 12 becomes the tangible item 200. The tangible 100 is enhanced 510, tagged 520, and encased 530 to create collectible asset 10 as discussed above with respect to FIG. 4. Likewise, digital assets 70 are created, stored 630, and transferred 640, 650 on a blockchain network as described above with respect to FIG. 4. If the physical asset 12 is not suitable for encasing, a replica 202 of primary asset 12 is created 614, and N+2 digital assets are created 612. Preferably, digital assets 70 include both two first digital assets 20, 25 (or tethered NFTs 20, 25), one for primary asset 12 and one for replica 202, and X second digital assets (or untethered NFTs 30). Optionally, one first digital asset 20 (tethered NFT) is tethered to both the primary asset 12 and collectible asset 10. Alternatively, digital assets 70 include only one first digital asset 20 (or tethered NFT 20) that links to both primary asset 12 and replica 202, and only N+1 digital assets need be created. Security tags 250, 252 are applied 522 to both the primary asset 12 if possible and the replica 202, and the replica 202 is optionally enhanced 212 and then encased 532 to create collectible asset 10. Digital assets are stored 632 on a network or platform using blockchain 80 for trade, control, or access on marketplace 50, tethered digital assets transfer 642 as a group with the primary asset 12 and collectible asset 10 and untethered digital assets transfer 650 independently.

FIGS. 7-9 illustrate examples of how owners 5 and buyers 6 connect on marketplace 50 to sell and buy physical and digital assets according to asset control protocols. As shown in FIG. 7, owners 5 of collectible assets 10 and NFTs 20, 25, 30 might use program 90 to register or enroll 710 their physical and digital assets on marketplace 50 where the digital assets 70 are stored on a database 94 accessible on a network 90. The owner can decide 712 whether any of its assets 10, 70 are for sale, registering 720 those that are not for sale as such and, if a collectible asset become lost or stolen 722, optionally registering 730 it as lost to alert buyers 6. An owner 5 might include a selection of information along with their assets, such as history or ownership, current status of physical item, artist, manufacturer, copyright information, royalty information, and details about the series and grade of item 10. Owners can also use the program 90 to sell 712 collected assets 10 and digital assets, setting the price 740 for collectible assets 10 and their tethered digital asset and setting the number and price 745 for any untethered digital assts. Displayed 750 on the marketplace 50 are the untethered NFTs 30 and/or connected groups 60 of collectible assets 10, physical assets 200, replicas, and tethered NFTs 20, 25 available for purchase.

As shown in FIG. 8, a buyer 5 can access the marketplace 50 when encountering 760 a collectible asset 10 for sale. Additionally, a buyer 5 can see what untethered NFTs 30 are available 766 and optionally report if they find a stolen or lost collectible asset 10. When a buyer 6 elects to purchase a connected group 60 or untethered NFTs 30, the transfer is verified and recorded using blockchain 80, and the buyer 6 either becomes the new collectible owner 5 (for connected groups 60) or a new owner 9 (for untethered NFTs 30). In more detail, by scanning 764 the collectible security tag 250, buyer 5 can check 762 if the collectible asset 10 is enrolled in the marketplace 50, check 764 if the collectible asset is for sale, and check if any associated untethered NFTs 30 are for sale 770. If the collectible asset 10 is for sale, the program 90 directs 790 the buyer 5 to a sale page for the collectible item 10 and any associated untethered NFTs 30. The program 90 then updates the blockchain depending 792 on what the buyer 5 purchases. If the buyer 5 purchases the collectible asset 10, the program 90 updates blockchain and transfers 794 the tethered NFT 20 to the buyer 5 with the purchase of the collectible asset 10, and the buyer 6 becomes 798 the new owner 5. If the buyer 5 purchases an untethered NFT 30, then the program updates blockchain, transfers 782 the untethered NFT 30 to the buyer 5, and reduces the number of untethered NFTs 30 for sale from the owner 5. Then, the buyer 6 is optionally prompted to register the untethered NFT 30 on the marketplace 50 as the new owner. If the collectible asset 10 is not for sale, then the buyer 6 is offered additional information depending on whether 770 any untethered NFTs are for sale and whether 772 the collectible asset 10 was registered as lost or stolen. For collectible assets 10 lost or stolen where no untethered NFTs are for sale, the buyer is informed 774 that the asset is lost or stolen and no NFTs are for sale. For collectible assets 10 that are lost or stolen where NFTs are for sale, the buyer 6 is optionally informed 776 that the collectible item 10 is lost and preferably directed to a sale page indicating the collectible item 10 is not for sale, but untethered NFTs are for sale. If the buyer wishes to purchase an NFT, then the purchase 782 proceeds as described above. Although not shown on FIGS. 7-8, any payments made with the sales can involve smart contracts and can include payments to the collectible owner 5 and, optionally, payments to the original creator or copyright owner for the collectible asset 10 or primary asset 12.

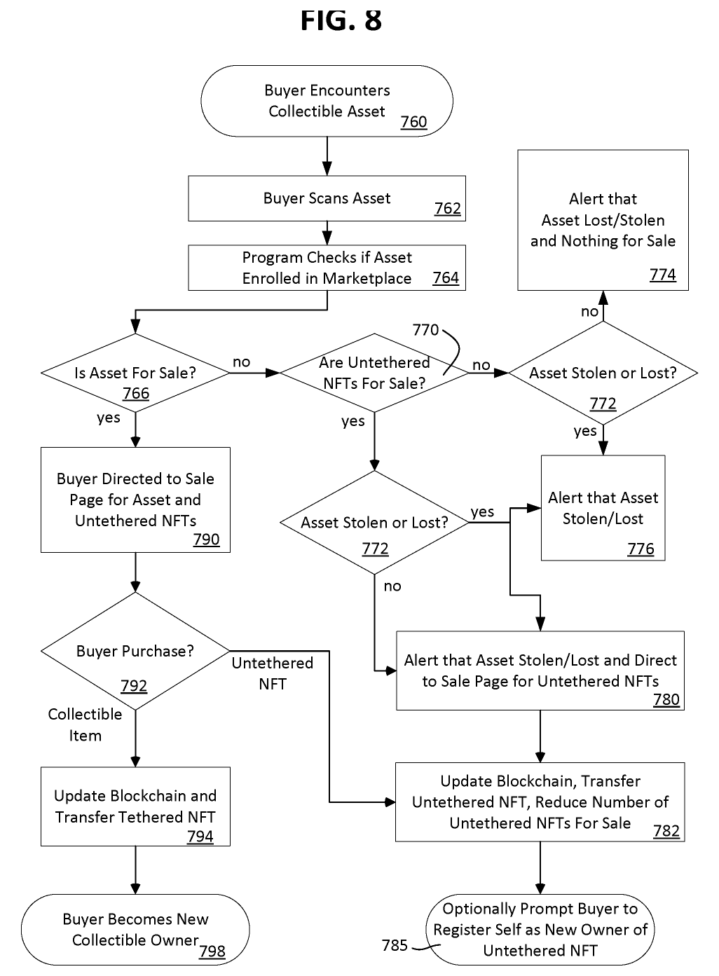

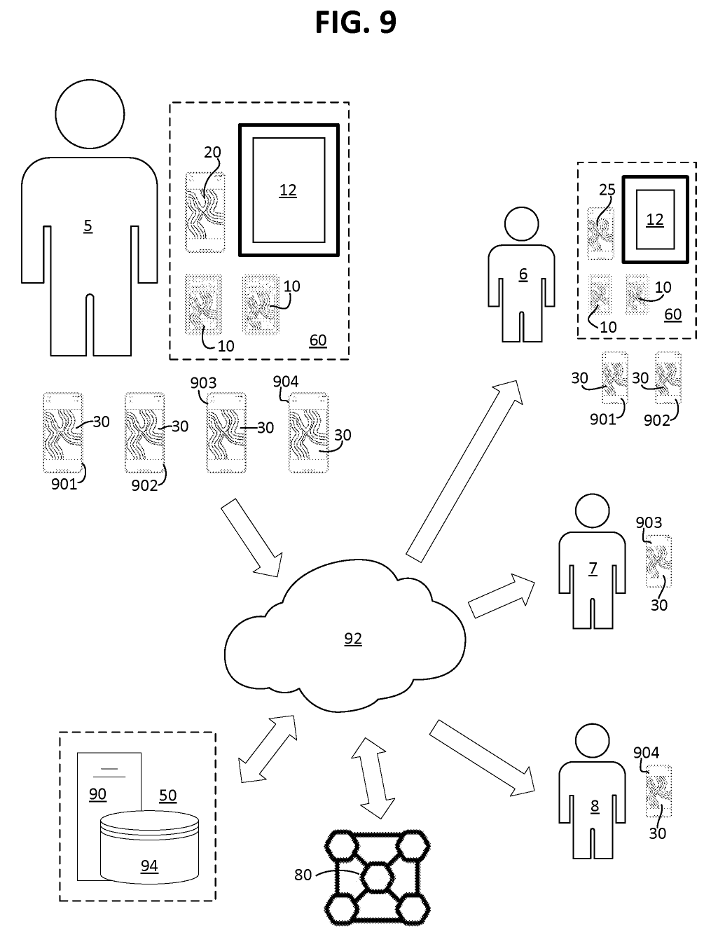

FIG. 9 illustrates how a seller or collectible owner 5 can transfer ownership to multiple buyers. As shown, owner 5 owns a collectible asset 10 that is part of a connected group 60 and offers to sell on the marketplace 50 the connected group 60 and four untethered NFTs, which are shown displayed on four mobile devices 901-904. The sale is facilitated using a platform or network 92 and blockchain 80, and the owner sells connected group 60 and two untethered NFTs 30 to a first buyer 6, one untethered NFT 30 to a second buyer 7, and another untethered NFT 30 to a third buyer. For all of the transactions, using blockchain offers security to the buyer and seller. For sale of any physical items, connecting them as a collectible asset 10 to a digital asset 70 provides an especially secure transaction that is serially identifiable, highly individualized, traceable, and resistant to counterfeiting. Using the online marketplace, collectible owners 5 have a way to register their collectibles 5, provide assurance to buyers, insurers, and others of their ownership, offer digital assets for sale with additional accessible information about related physical and digital assets, provide verification and assurances to the buyers of their physical assets, and further monetize sales through smart contracts and royalties.

FIGS. 10-11 illustrate how the present invention can be applied to primary assets 800 having multiple owners. For example, a painting, trading card, collectible coin, or parcel of real property may have multiple owners who each one a fraction of the total value of the primary asset 800. These fractional owners 810 can enjoy greater security by linking their fractional ownership 810 to the primary asset 800 using collectible assets 10 and blockchain based digital assets 70 to memorialize their ownership interests and dictate how the asset is controlled. FIG. 10 illustrates one example, where three fractional owners 810 share ownership of real property 800. Each fractional owner 810 has their interest in the real property 800 further secured by collectible assets 10 that encases replicas (or some other representation) 802, 804 of the property they collectively own. Each collectible asset 10 includes a security tag 852, 854, which is linked to a digital asset 70 such as an NFT 882, 884. Preferably, the primary asset 800 itself or an ownership document can also include a primary security tag 850, which can be linked to one or all of the collectible assets 10 and associated tethered digital assets 882, 884.

Optionally, each of their collectible assets 10 can show their owner’s respective fractional ownership percentages 820. Also optionally, one of the collectible assets 10 can encase a master replica 802 and master security tag 852 while the other collectible assets 10 encase stakeholder replicas 804 and stakeholder security tags 854, which may be particularly useful where one fractional owner 810 enjoys a greater percentage of ownership in the asset than the other fractional owners 810 or enjoy greater control of the asset 800. In some embodiments, additional untethered NFTs 30 may also be issued for the asset 800.

Primary asset 800, collectible assets 10, and tethered NFTs 882, 884 are considered a group of tethered assets 60, with transfer of the entire asset 800 preferably requiring presence of all fractional owner 810 group members who are authenticated by their possession of their respective collectible assets 10 and tethered NFTs 882, 884. Optionally and preferably, each fractional owner 810 can transfer their individual ownership interest in primary asset 800 by transferring their respective collectible asset 10 and tethered NFT 882, 884. Additional arrangements or transfer protocols can be required as well, such as requiring presence of the master replica 802 and/or the primary asset 800 itself in addition to the individual fractional owner’s collectible asset 10 and tethered NFT 882, 884. Preferably, any asset control protocols are established when the ownership in a primary asset 800 is first divided among the fractional owners.

FIG. 11 illustrates how fractional owners 810 can secure and optionally trade their interest in primary asset 800 on a marketplace. While FIG. 11 provides an example where one fractional owner 810 receives a master replica 802 and the remaining fractional owners 810 receive stakeholder replicas 804, the master replica 802 can be identical to the stakeholder replicas 804 where all ownership interests are identical or where no fractional owner 810 is to receive unique privileges or responsibilities. For some assets 800, it may also be appropriate to have multiple master replicas 802.

Once a primary asset 800 has been identified 1100, the number N of fractional owners 810 should be determined 1105. Additionally, the number U, if any, of untethered digital assets 30 that are to be associated with asset 800 should be determined 1110, and N+U digital assets 70 should be created 1115. Next, it should be determined whether 1120 the primary asset 800 is suitable for encasement or encapsulation. If primary asset 800 is suitable for encasement or encapsulation, N-1 stakeholder replicas 804 are created 1125, primary asset 800 is optionally secured 1130 with master security tag 852, which is associated with master tethered NFT 882, and stakeholder replicas 804 are secured 1145 with stakeholder security tags 854, which are associated with stakeholder tethered NFTs 884. If asset 800 is not suitable for encasement or encapsulation, a master replica 802 is created 1135 and is secured 1140 with master security tag 852, which is associated with master tethered NFT 882, and N-1 stakeholder replicas 804 are created 1145 and secured with stakeholder security tags 854, which are associated with stakeholder tethered NFTs 884. Optionally, the primary asset 800 is further secured with a primary security tag 850. The security tags 850, 852, 854 and tethered NFTs 882, 884 are secured via blockchain as discussed above. Additionally, untethered NFTs 30 can be created 1150 as well.

After applying security tags 852, 854 to master replica 802 (or primary asset 800) and stakeholder replicas 804, they can be enhanced 1155 such as by showing ownership percentages, quality grading, and certifications as discussed above and then encased or encapsulated 1160 as described above to create collectible assets 10, each representing a fractional ownership of primary asset 800. Preferably, each collectible asset 10 is assigned 1165 a fractional value representing the ownership interest associated with the collectible asset 10. For example, the collectible asset 10 containing the primary asset 800 or master replica 802 will be assigned a master fractional value MV, and each collectible asset 10 containing a stakeholder replica 804 will be assigned a stakeholder fractional value SV. Not all stakeholder fractional values SV need be the same, but the sum of all of the stakeholder fractional values SV plus the master fractional value MV should equal 100%.

The master tethered NFT 852 and all stakeholder tethered NFTs 854 as well as any untethered NFTs 30 are all stored 1170 on the blockchain network 80 for trade and access, optionally on marketplace 50 according to the established asset control protocols. Preferably, untethered NFTs 30 can be transferred 1175 without restriction, but the master tethered NFT 882 and each stakeholder tethered NFT 884 must be transferred 1180 with its linked collectible asset 10 and optionally as a group of tethered assets 60 or as a subset of group 60.

FIGS. 12-13 illustrate how the present invention can also be used for memberships 900. For example, a club or organization (e.g., golf club, museum, social club, networking group) may issue memberships 900 to entities, individuals, or membership holders 910, and the memberships 900 may have financial and/or non-financial benefits of value to the membership holders 910. Using the methods described herein, a membership 900 can be represented by a collectible asset 10 with a tethered NFT 982, 984. FIG. 12 illustrates one example, where three membership holders 910 share a group or family membership 900 to a club. Each membership holder 910 has their membership 900 secured by a collectible asset 10 that encases a representation of membership such as a membership card 902, 904. Each collectible asset 10 includes a collectible item or membership security tag 952, 954, which is linked or tethered to a digital asset 70 such as an NFT 982, 984. Preferably, a document memorializing the membership 900 can also include a primary security tag 950, which can be linked to one or all of the collectible assets 10 and associated tethered digital assets 982, 984.

Optionally, each of their collectible assets 10 can show or be enhanced with their membership owner’s membership information 920. Also optionally, one of the collectible assets 10 can contain a master membership card 902 and master membership security tag 952 while the other collectible assets 10 encase family, group, or secondary membership cards 904 and secondary membership security tags 854, which may be particularly useful where one membership holder 910 controls or enjoys more membership benefits than the other membership holders 910. In some embodiments, additional untethered NFTs 30 may also be issued for the membership 900, and the untethered NFTs can optionally represent unlimited or limited-use membership services, meals, guest passes, or something similar.

Membership 900, collectible assets 10, and tethered NFTs 982, 984 are preferably considered a group 60, with transfer of the entire membership 900 requiring presence of all membership holders 910 who are authenticated by their possession of their respective collectible asset 10 and tethered NFT 982, 984. Optionally and preferably, individual membership holders 910 can transfer or bequeath their individual membership 900 by transferring their respective collectible asset 10 and tethered NFT 982, 984. Additional arrangements or transfer protocols can be required, however, such as requiring presence of the primary membership holder 910 and/or the membership 900 document itself in addition to the individual membership owner’s collectible asset 10 and tethered NFT 982, 984. Preferably, asset control protocols are established before or when creating or signing the membership agreement for membership 900.

FIG. 13 illustrates how membership holders 910 can secure and optionally trade their membership 900 on a marketplace. While FIG. 13 provides an example where one membership holder 910 has a primary membership card 902 and the remaining membership holders 910 have secondary membership cards 904, the primary membership card 902 can be identical to the secondary membership cards 904 where all membership interests are identical or where no membership holder 910 is to receive unique privileges or responsibilities. Likewise, there can be multiple primary membership cards 902 where multiple membership holders 910 share certain privileges or responsibilities.

Once a membership 900 has been identified, the number N of membership holders 910 should be determined 1300. Additionally, the number U, if any, of untethered digital assets 30 that are to be associated with membership 900 should be determined 1305, and N+U digital assets 70 (NFTs) should be created 1310. For each membership 900, a master membership cards 902 is created 1315 and secured 1320 with a master membership security tag 952, which is associated 1320 with master membership tethered NFT 982, and N-1 secondary membership cards 904 are created 1315 and secured 1330 with secondary membership security tags 954, which are associated 1330 with secondary membership tethered NFTs 984. Optionally, the membership 900 document is further secured 1325 with a document or primary security tag 950. The security tags 950, 952, 954 and tethered NFTs 982, 984 are secured 1355 via blockchain as discussed above. Additionally, untethered NFTs 30 can be created 1335, optionally to represent additional services, meals, guest passes, or other membership privileges.

After applying master and secondary membership security tags 952, 954 to master membership card 902 and secondary membership cards 904, they can be enhanced 1340 such as by showing membership levels, access privileges, club information, and certifications as discussed above and then encased or encapsulated 1345 as described above to create collectible assets 10, each representing a membership holder’s 910 membership. Preferably, each collectible asset 10 is assigned or associated 1350 with certain membership privileges representing the membership holder’s 910 rights associated with their membership 900. For example, the collectible asset 10 containing the primary membership card 902 will be assigned all-access or administrator access privileges, and each collectible asset 10 containing a secondary membership card 904 will be assigned a subset of such access and privileges.

The primary tethered NFT 952 and all secondary tethered NFTs 954 as well as any untethered NFTs 30 are all stored 1355 on the blockchain network 80 for trade and access, optionally on marketplace 50. Preferably, untethered NFTs 30 can be transferred 1360 without restriction, but the primary tethered NFT 982 and each secondary tethered NFT 984 must be transferred 1365 with its linked collectible asset 10 and optionally as a group 60 or as a subset of group 60, which can ensure memberships 900 are transferred according to membership transfer rules including provisions relating to the death or incapacity of a membership holder 910.

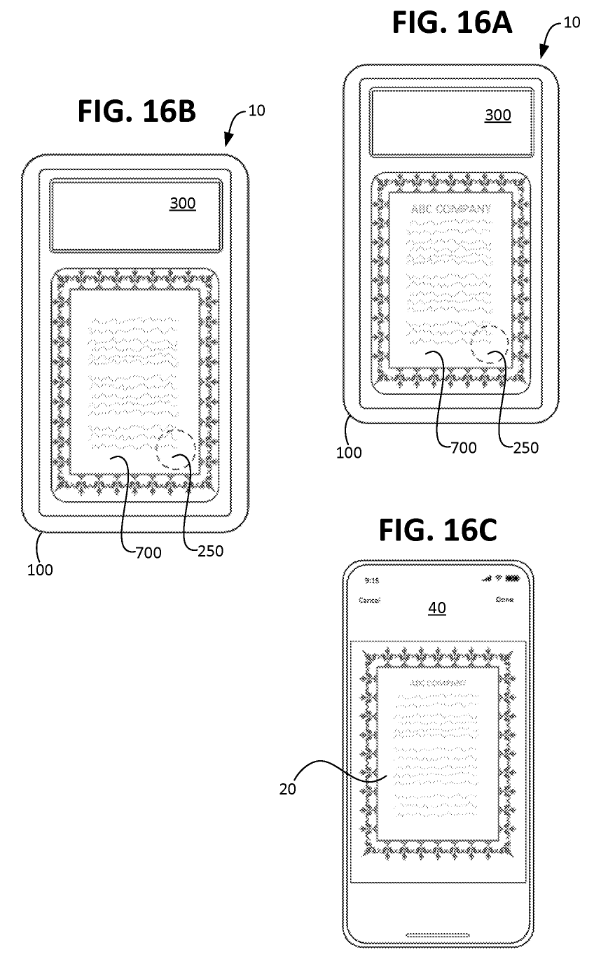

FIGS. 1E and 14-16C illustrate examples of tangible items 200 suitable for encapsulation, pairing with digital assets, and either monetization or certification using a blockchain based marketplace. FIG. 14 illustrates a diploma 500 stored in protective case 100 with security tag 250, FIG. 15 illustrates a certificate 600 such as a stock certificate store in protective case 100 with security tag 250, and FIG. 1E illustrates a coin 601 representing precious metal ownership (e.g., a mint, mining, bar, or batch that is stored elsewhere). FIGS. 16A-16B illustrate a front view (FIG. 16A) and a back view (FIG. 16B) of a second and preferred embodiment of a stock certificate 700 sized as a trading card and stored in protective case 100 with security tag 250. FIG. 16C illustrates the digital asset 70 as a tethered NFT 20 displayed on a mobile device 40. For the diploma 500, certificate 600, and coin 601, physical case 100 is preferably sized to accommodate the physical item and optionally includes an encased information card 300 or sheet where appropriate and desired. Also for any diplomas 500, certificates 600, and coins 601 replicas 202 can be created and encapsulated as well as described herein. For stock certificate 700, it is preferably sized as a trading card and also optionally includes an information card. Additionally, security tag 250 can be selected, applied, and encapsulated, and preferably security tag 250 is embedded within the diploma 500 or certificate 600, 700. Additionally, digital assets 70 can be created and associated with the physical items according to any of the methods described herein. Accordingly, tethered NFTs 20 can be created for diplomas 500, coins 601, and certificates 600, 700 for certifying the owner, establishing an immutable chain containing the history of the asset, and confirming the authenticity of the diploma 500, coin 601, or certificate 600, 700. For example, using the methods and materials described herein for diplomas 500, a graduate can preserve and display their original diploma 500 while using their associated tethered NFT 20 to provide instantly verifiable proof of their credentials including such details as their degree or certification, their identity, the issuing institution, the date of graduation. This removes fraud, intermediaries, and delay. Likewise, using the methods and materials described herein for certificates 600 such as stock certificates, an investor can preserve their original certificate 600 while using their associated tethered asset 20 to provide instantly verifiable proof of ownership including such details as issuing company, number of shares, issue date, certificate number, registration number, shareholder name and address, transaction and custody history, and value. For bars, mints, batches, or collections of precious metals, using the methods and materials described herein, an investor can store their precious metals in a secure location while using their associated tethered collectible asset 200 and digital asset 20 to provide instantly verifiable proof of ownership including such details as weight, purity, origin, serial number, batch number, refinery lot, certificate number, registration number, owner name and address, transaction and custody history, and value. As with all digital assets 70, the tethered NFT 20 can be stored in a digital wallet for convenience. For both diplomas 500 and certificates 600, 700, tethering the document to blockchain enhances the value of the physical item while allowing its owner quick access to their benefits.

While there has been illustrated and described what is at present considered to be the preferred embodiment of the present invention, it will be understood by those skilled in the art that various changes and modifications may be made and equivalents may be substituted for elements thereof without departing from the true scope of the invention disclosed, but that the invention will include all embodiments falling within the scope of the claims.

I claim:

1. A method of authenticating and managing a primary asset using a decentralized computing system, the method comprising:
a) identifying the primary asset;
b) producing a collectible asset representative of the primary asset, the collectible asset comprising:
i) a tamper-resistant case;ii) a tangible item encapsulated in the case; andiii) a collectible item security tag encapsulated in the case;
c) generating a first digital asset representative of the primary asset, wherein the first digital asset is secured by a non-fungible token and stored on the decentralized computing system;
d) using the decentralized computing system, tethering the first digital asset to the collectible asset, wherein the tethered first digital asset, the primary asset, and the collectible asset comprise a first group of tethered assets; and
e) using the decentralized computing system, restricting control of the first digital asset such that it can only be controlled according to asset control protocols for control of the first group of tethered assets.

2. The method of claim 1 further comprising:
a) attaching a primary security tag to the primary asset; and
b) using the decentralized computing system, further tethering the primary security tag to the first digital asset and the collectible asset.

3. The method of claim 2 wherein the primary asset is a non-fungible asset.

4. The method of claim 3 wherein the tangible item is a two-dimensional representation of the primary asset.

5. The method of claim 1 wherein the tangible item is the primary asset.

6. The method of claim 1 wherein the primary asset is an intangible asset.

7. The method of claim 1 wherein the collectible item security tag is an authentication-type near field communication chip.

8. The method of claim 1 further comprising generating one or more second digital assets representative of the primary asset, wherein each of the second digital assets is secured by a non-fungible token stored on the decentralized computing system.

9. The method of claim 8 further comprising:
a) using the decentralized computing system, tethering each of the second digital assets to the collectible asset; and
b) restricting control of the second digital assets on the decentralized computing system such that they can only be controlled according to asset control protocols for control of the first group of tethered assets.

10. The method of claim 8 further comprising allowing unrestricted control of each second digital asset on the decentralized computing system independently from control of the first group of tethered assets.

11. The method of claim 9 further comprising:
a) generating one or more third digital assets representative of the primary asset, wherein each of the third digital assets is secured by a non-fungible token stored on the decentralized computing system; and
b) allowing unrestricted control of each third digital asset on the decentralized computing system independently from the control of the first group of tethered assets.

12. The method of claim 1 further comprising registering the first digital asset in a database accessible on the decentralized computing system for the purpose of selling, tracking, or notifying others of the first digital asset, the primary asset, or the collectible asset.

13. The method of claim 8 further comprising registering each of the plurality of second digital assets in a database accessible on the decentralized computing system for the purpose of selling, tracking, or notifying others of the second digital assets.

14. The method of claim 1 wherein
the collectible asset comprises a plurality of collectible assets, each representing shared rights to the primary asset, and
the collectible security tag comprises a plurality of collectible security tags, each of the collectible assets being enhanced with one of the plurality of collectible security tags.

15. The method of claim 14 wherein
the primary asset comprises an asset shared by a group of fractional owners,
the plurality of collectible assets comprises a plurality of stakeholder collectible assets, each stakeholder collectible asset representing a fractional owner’s fraction of ownership of the primary asset,
the plurality of collectible security tags comprises a plurality of stakeholder security tags, each stakeholder collectible asset being enhanced with one of the plurality of stakeholder security tags, and
the first digital asset comprises a plurality of stakeholder digital assets stored on the decentralized computing system, each stakeholder digital asset being linked to one of the plurality of stakeholder security tags and thereby one of the plurality of stakeholder collectible assets.

16. The method of claim 15 wherein the protocols for control of the group of tethered assets comprises permitting transfer of the primary asset on the decentralized computing system only if the plurality of stakeholder collectible assets, the plurality of stakeholder digital assets, and the primary asset transfer together.

17. The method of claim 15 wherein the protocols for control of the group of tethered assets comprises permitting transfer of a first one of the plurality of stakeholder digital assets on the decentralized computing system where the first one of the plurality of stakeholder digital assets transfers with its linked stakeholder digital assets and fractional owner’s rights to the primary asset.

18. Method of claim 14 wherein
the primary asset comprises a membership agreement between a member and an organization,
the plurality of collectible assets comprises a plurality of membership cards, each representative of the membership agreement,
the first digital asset is a plurality of first digital assets, each linked to one of the plurality of membership cards, and
the protocols for control of the group of tethered assets comprises permitting transfer of the membership agreement on the decentralized computing system only if the plurality of membership cards, the plurality of first digital assets, and the membership agreement transfer together.

19. Method of claim 14 wherein
the primary asset comprises a membership agreement between a membership group and an organization,
the membership group comprises a master member and a plurality of secondary members,
the plurality of collectible assets comprises a master membership card and a plurality of secondary membership cards, wherein the master membership card represents the master member of the membership group, and each secondary membership card represents a secondary member of the membership group,
the membership card for the master member is linked to the first digital asset stored on the decentralized computing network and to a plurality of master membership privileges stored on and accessible through the decentralized computing network,
each of the plurality of secondary membership cards are tethered to one of a plurality of second digital assets stored on the decentralized computing network and to a plurality of secondary membership privileges stored on and accessible through the decentralized computing network, and
the protocols for control of the group of tethered assets comprises permitting transfer of the membership agreement on the decentralized computing system only if the master membership card, the plurality of secondary membership cards, the plurality of first digital assets, the plurality of second digital assets, and the membership agreement transfer together.

20. A method of authenticating and managing a primary asset using a decentralized computing system, the method comprising:
a) identifying the primary asset;
b) producing a collectible asset representative of the primary asset, the collectible asset comprising:
i) a tamper-resistant protective case;ii) a tangible item encapsulated in the protective case; andiii) a collectible item security tag encapsulated in the protective case;
c) generating a first digital asset representing the primary asset, wherein the first digital asset is secured by a non-fungible token and stored on the decentralized computing system;
d) generating a plurality of second digital assets representing the primary asset, wherein each of the second digital assets is secured by a non-fungible token and stored on the decentralized computing system;
e) tethering the first digital asset to the collectible item security tag of the collectible asset using the decentralized computing system, wherein the tethered assets comprise a first group of tethered assets;
f) registering the first digital asset in a database accessible on the decentralized computing system for the purpose of selling, tracking, or notifying others of the first digital asset, the primary asset, or the collectible asset;
g) registering each of the second digital assets in a database accessible on the decentralized computing system for the purpose of selling, tracking, or notifying others of the second digital asset, the first digital asset, the primary asset, or the collectible asset;
i) allowing unrestricted control of each of the second digital assets on the decentralized computing system.
